(19) United States
(12) Patent Application Publication
(10) Pub. No.: US 2014/0160132 A1
(43) Pub. Date: Jun. 12, 2014

(54) VISUAL REPRESENTATIONS OF STRUCTURED ASSOCIATION MAPPINGS

(71) Applicants: Eric P. Xing, Pittsburgh, PA (US); Ross Eugene Curtis, Cedar Hills, UT (US)

(72) Inventors: Eric P. Xing, Pittsburgh, PA (US); Ross Eugene Curtis, Cedar Hills, UT (US)

(73) Assignee: CARNEGIE MELLON UNIVERSITY, Pittsburgh, PA (US)

(21) Appl. No.: 14/131,974

(22) PCT Filed: Jul. 12, 2012
(86) PCT No.: PCT/US12/46435

§ 371 Date: Feb. 26, 2014

Related U.S. Application Data
(60) Provisional application No. 61/572,137, filed on Jul. 12, 2011.

(51) Int. Cl. G06T 11/20

(52) U.S. Cl. CPC G06T 11/206
USPC 345/440

(57) ABSTRACT

A method performed by one or more processors, comprising: receiving genomic data and trait data representative of a plurality of traits of one or more individuals; determining a structure of one or more of the genomic data and the trait data; selecting, in response to the determined structure, a structured association algorithm for execution with the genomic data and the trait data; generating, based on execution of the selected, structured association algorithm against the genomic data and the trait data, structured association data indicative of associations among the genomic data and the trait data, wherein the associations are at least partly identified based on the structure; and generating data for a graphical user interface, that when rendered on a display device, comprises: a visual representation of at least a portion of the structured association data.

### CLAIM OF PRIORITY

This application claims priority under 35 U.S.C. §119(e) to provisional U.S. Patent Application No. 61/572,137, filed on Jul. 12, 2011, the entire contents of which are hereby incorporated by reference.

### BACKGROUND

Generally, a gene association mapping includes data specifying associations between DNA (and/or DNA mutations) and genes. For example, a gene association mapping may link DNA mutations to a particular gene, possibly leading to treatments for diseases. In an example, systems for implementing gene association mapping identify associations between DNA mutations and genes by identifying associations between DNA mutations and a particular gene in the association mapping. These associations are identified one at time, e.g., for particular genes. For example, to identify associations between DNA mutations and a particular gene, the systems perform a series of processes for identifying associations between the DNA mutations and the particular gene. To identify associations between the DNA mutations and another gene, the systems re-perform the series of processes for identifying associations between the DNA mutations and the other gene.

### SUMMARY

In one aspect of the present disclosure, a method performed by one or more processors includes receiving genomic data and trait data representative of a plurality of traits of one or more individuals; determining a structure of one or more of the genomic data and the trait data; selecting, in response to the determined structure, a structured association algorithm for execution with the genomic data and the trait data; generating, based on execution of the selected, structured association algorithm against the genomic data and the trait data, structured association data indicative of associations among the genomic data and the trait data, wherein the associations are at least partly identified based on the structure; and generating data for a graphical user interface, that when rendered on a display device, includes: a visual representation of at least a portion of the structured association data.

Implementations of the disclosure can include one or more of the following features. In some implementations, determining the structure includes: determining the structure based on one or more of (i) dependencies among items of the genomic data, and (ii) dependencies among items of the trait data. In other implementations, the genomic data is representative of a plurality of single nucleotide polymorphisms (SNPs). In still other implementations, the visual representation includes one or more of a gene network representation, a node-edge representation, a heat map representation, an association tree representation, and a population association representation. In yet other implementations, the method includes filtering the structured association data.

In some implementations, the method includes generating data to update the graphical user interface with a visual representation of the filtered structured association data. In still other implementations, the method includes receiving a selection of a portion of the visual representation; and causing the graphical user interface to be updated with data pertaining to structured association data displayed in the selected portion. In other implementations, the graphical user interface includes a first graphical user interface, and the method further includes: generating data for a second graphical user interface, that when rendered on the display device, includes: a visual representation of the structure.

In still another aspect of the disclosure, one or more machine-readable media are configured to store instructions that are executable by one or more processors to perform operations including receiving genomic data and trait data representative of a plurality of traits of one or more individuals; determining a structure of one or more of the genomic data and the trait data; selecting, in response to the determined structure, a structured association algorithm for execution with the genomic data and the trait data; generating, based on execution of the selected, structured association algorithm against the genomic data and the trait data, structured association data indicative of associations among the genomic data and the trait data, wherein the associations are at least partly identified based on the structure; and generating data for a graphical user interface, that when rendered on a display device, includes: a visual representation of at least a portion of the structured association data. Implementations of this aspect of the present disclosure can include one or more of the foregoing features.

In still another aspect of the disclosure, an electronic system includes one or more processors; and one or more machine-readable media configured to store instructions that are executable by the one or more processors to perform operations including: receiving genomic data and trait data representative of a plurality of traits of one or more individuals; determining a structure of one or more of the genomic data and the trait data; selecting, in response to the determined structure, a structured association algorithm for execution with the genomic data and the trait data; generating, based on execution of the selected, structured association algorithm against the genomic data and the trait data, structured association data indicative of associations among the genomic data and the trait data, wherein the associations are at least partly identified based on the structure; and generating data for a graphical user interface, that when rendered on a display device, includes: a visual representation of at least a portion of the structured association data. Implementations of this aspect of the present disclosure can include one or more of the foregoing features.

All or part of the foregoing can be implemented as a computer program product including instructions that are stored on one or more non-transitory machine-readable storage media, and that are executable on one or more processors. All or part of the foregoing can also be implemented as an apparatus, method, or electronic system that can include one or more processors and memory to store executable instructions to implement the stated operations.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 an example of a network environment for generating visualizations of a structured association mapping.

FIGS. 2-8 are examples of various visualizations that are based on associations among genomic data and trait data.

FIG. 9 is a flowchart of a process for generating a visualization of a structured association mapping.

FIG. 10 is a block diagram of components in an example environment for generating visualizations of a structured association mapping.

### DETAILED DESCRIPTION

Generally, a structured association mapping includes data specifying associations (e.g., relationships, correlations, causal effects, and so forth) among items of data from data sets, where the association is at least partly identified based on a structure of the data in and among the data sets. For example, structured association mapping is based on a machine learning approach that leverages structure in the data in order to enhance the discovery of associations, e.g., associations that may not be identified through only association mapping. In an example, a structure includes data indicative of linkages and/or dependencies among items of data in a data set.

In an example, a DNA mutation may be associated with two, different phenotypes, because the DNA mutation has a causal effect on the two, different phenotypes. Additionally, the structure between the phenotypes indicates a dependency between the phenotypes. In this example, an association mapping among the DNA mutation and the phenotypes fails to detect the causal effect, and thus the association, between the DNA mutation and the phenotypes. However, because the structure between the phenotypes indicates a dependency between the phenotypes, a structured association mapping detects the causal effect, and thus the association, between the DNA mutation and the phenotypes. That is, the structured association mapping detects the association between the DNA mutation and the phenotypes, because the structured association mapping uses the dependencies between the phenotypes in detecting associations between the DNA mutation and the phenotypes.

In an example, a system implements structured association mapping on a first data set and a second data set. In this example, the first data set includes genomic data, including, e.g., data indicative of a genome (e.g., a genetic makeup of a cell). A genome is encoded either in DNA, or, for many types of viruses, in RNA. The genome includes both the genes and the non-coding sequences of the DNA/RNA. For example, genomic data may include data indicative of mutations in the genome at the DNA level and/or genetic polymorphisms. There are numerous types of genetic polymorphisms, including, e.g., a single-nucleotide polymorphism (SNP).

In a SNP, one nucleotide is different between individuals. For example, some individuals may inherit a G nucleotide at a particular location, instead of the A nucleotide that is common in the population. Although many SNPs make little or no difference to gene expression levels and the normal functioning of a cell, some SNPs can have a much larger effect. The inheritance of SNPs that turn off genes, or change the coding sequence of genes, can interact with other genes to lead to disease. Using the techniques described herein, SNPs affecting gene expression levels and the functioning of cells are identified.

As previously described, a system implements structured association mapping on the first data set and a second data set. In an example, the second data set includes trait data, including, e.g., data specifying clinical traits in individuals, data indicative of gene expression measurements in individuals (e.g., individuals with known diseases), phenotypes of individuals, and so forth.

In this example, both the first and the second data sets include thousands (e.g., hundreds of thousands) of items of data. The system is configured to implement structured association algorithms across the first and the second data sets, at a substantially simultaneous time (e.g., rather than implementing the structured association algorithms one at a time for particular items of data). Generally, structured association algorithms include a series of instructions for identifying an association between one item of data and another item of data, at least partially based on the structure between the items of data.

Based on execution of the structured association algorithms, the system identifies a structured association mapping. The structured association mapping can lead users of the system to conclusions about data in the data sets and other hypotheses to be tested in future studies. Additionally, the system is also configured to determine a strength of the associations in the structured association mapping, e.g., in absolute terms using a pre-defined scale and/or in relative terms. The system is configured to present a user with a visualization of the associations among one or more items of genomic data and one or more items of trait data, along with the strengths of the associations. That is, the system includes a visual analytics system for structured association mapping. For example, the system provides users with various visualizations of relevant SNPs and associated traits. Through the visualizations, users may explore the structure of the genomic data and trait data, while also exploring association strengths.

In an example, the visualizations provide users an overview of the results, while also allowing the user to identify specific gene-genome interactions. Once a user has used the system to identify a particular interaction, the user can explore the interaction through a tool, generated by the system, that provides the user with external links to biological databases, such as a UniProt database, a dbSNP database, and other databases. Accordingly, the system promotes the exploration of a structured association mapping through the integration of multiple representations, e.g., so that a user can explore the structure of the traits, while considering an association of the traits to the genome.

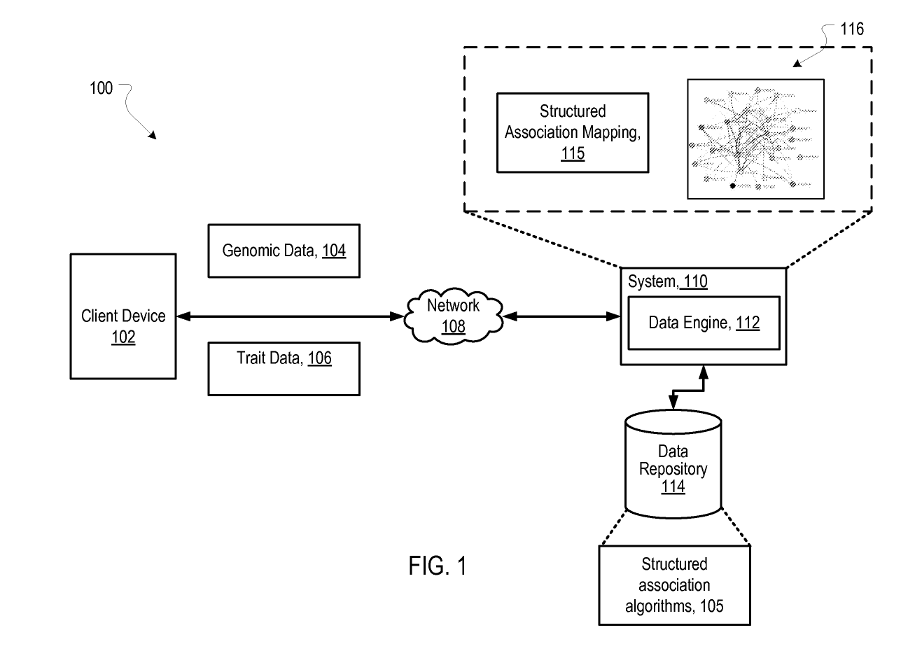

Referring to FIG. 1, a block diagram is shown of an example environment 100 for generating visualization 116 of structured association mapping 115. The example environment 100 includes network 108, including, e.g., a local area network (LAN), a wide area network (WAN), the Internet, or a combination thereof. Network 108 connects client device 102 and system 110. The example environment 100 may include many thousands of client devices and systems. The example environment 100 also includes data repository 114 for storing numerous items of data, including, e.g., structured association mapping 115, visualization 116, genomic data 104, trait data 106, and structured association algorithms 105.

Client device 102 includes a personal computer, a laptop computer, and other devices that can send and receive data over network 108. In the example of FIG. 1, client device 102 sends, to system 110, genomic data 104 and trait data 106. In this example, client device 102 may include a device operated by an entity that differs from an entity that operates system 110. The entity that operates client device 102 collects genomic data 104 and trait data 106. For example, trait data 106 may be collected from various individuals included in a particular segment and/or segments of a population. Genomic data 104 may include various SNPs for which a researcher wants to identify associated genes.

In this example, system 110 includes data engine 112. Additionally, data repository 114 is configured to store structured association algorithms 105. Using genomic data 104 and trait data 106, data engine 112 is configured to generate structured association mapping 115, e.g., based an application of one or more of structured association algorithms 105 to genomic data 104 and trait data 106. Using structured association mapping 115, data engine 112 is also configured to generate visualization 116, which includes a visualization of the associations among items of genomic data 104 and items of trait data 106, e.g., as specified in structured association mapping 115. A user of system 110 may zoom into portions of visualization 116, e.g., to view additional information for the portions and/or to access external databases that provide additional information for the portions.

In the example of FIG. 1, system 110 implements an association study, e.g., to identify associations between genomic data 104 and trait data 106. The association study includes various individuals. Genomic data 104 is collected as SNPs for hundreds of thousands to millions of SNPs, and trait data 106 is collected as gene expression data from a microarray or as clinical trait data. Data engine 112 provides tools to create and visualize the structure for both of these data types separately.

As previously described, system 110 executes one or more of structured association algorithms 105 in generating structured association mapping 115. System 110 promotes selection of appropriate structured association algorithms 105 by providing visualizations of the structure of genomic data 104 and/or of the structure of trait data 106. Through the visualization of the structure, a user of system 110 may explore genomic data 104 and trait data 106 to decide on an appropriate one of structured association algorithms 105. For example, if the user notices strong population stratification in the data, the user will want to perform a population analysis to find associations. In this example, the user selects a structured association algorithm pertaining to population analysis. If the user notices that the traits form many highly connected clusters (relative to the connectedness of other clusters), the user will want to use an algorithm that includes a regression approach to find associations from SNPs to a cluster of highly related traits or genes, including, e.g., the GFlasso algorithm.

In an example, system 110 identifies a structure among items in genomic data 104 and a structure among items in trait data 106 based on execution of structure algorithms. Generally, a structure algorithm includes a series of instructions that are executable by a processor to identify links and or dependencies among items of data.

In another example, system 110 identifies structure among items in genomic data 104 and structure among items in trait data 106 based on input received from a user of system 110. In this example, the user inputs into system 110 information indicative of the structure.

In an example, system 110 is configured to automatically select one or more of structured association algorithms 105, e.g., based on the identified structure of genomic data 104 and trait data 106. In this example, system 110 selects the one or more of structured association algorithms 105 based on information associated with each of structured association algorithms 105 with a particular type of structure and based on the particular type of structure identified for genomic data 104 and/or for trait data 106. In another example, a user inputs into system 110 a selection of one or more of structured association algorithms 105 to be used with genomic data 104 and trait data 106.

Following selection of an appropriate one of structured association algorithms 105 for genomic data 104 and trait data 106, data engine 112 implements the selected structured association algorithm 105 against genomic data 104 and trait data 106. In an example, system 110 implements (e.g., automatically and in real-time) structured association algorithms 105 on genomic data 104 and trait data 106 using parallelization. Generally, parallelization includes a technique in which multiple processes are executed in parallel with each other. For example, data engine 112 may execute numerous structured association algorithms 105 at a same time (e.g., in parallel with each other) against genomic data 104 and trait data 106.

Using the results of execution of the structured association algorithms 105, data engine 112 generates structured association mapping 115. As described in further detail below, system 110 providers a user with numerous tools for exploration of the associations among genomic data 104 and trait data 106, e.g., as specified by structured association mapping 115. For example, system 110 provides a user with an overview of structured association mapping 115. In this example, the overview is provided as a visualization. Through the visualization, geneticists can quickly identify whether SNPs are generally associated with other traits in the same part of a gene network. Generally, a gene network includes a graph of visual representations of various genes in relation to each other, e.g., based on characteristics of the various genes. Hereinafter, a gene network may be referred to as a network.

Once the geneticist has a feel for the overall structured association mapping 115, the geneticist can start to zoom and filter to the most interesting patterns in the data. Geneticists can then identify specific trait clusters that are associated with genetic loci. Geneticists can also zoom in to see the clustered network and correlation structure of the traits of interest. Finally, once the geneticist has zoomed into a particular interaction, system 110 provides details on demand to specifically characterize the association.

Additionally, researchers can query online resources directly from a graphical user interface generated by system 110, e.g., in order to find out the function of key genes in the network. Through graphical user interfaces provided by system 110, researchers can also look up SNPs online to find out why particular SNPs might be associated with the traits of interest.

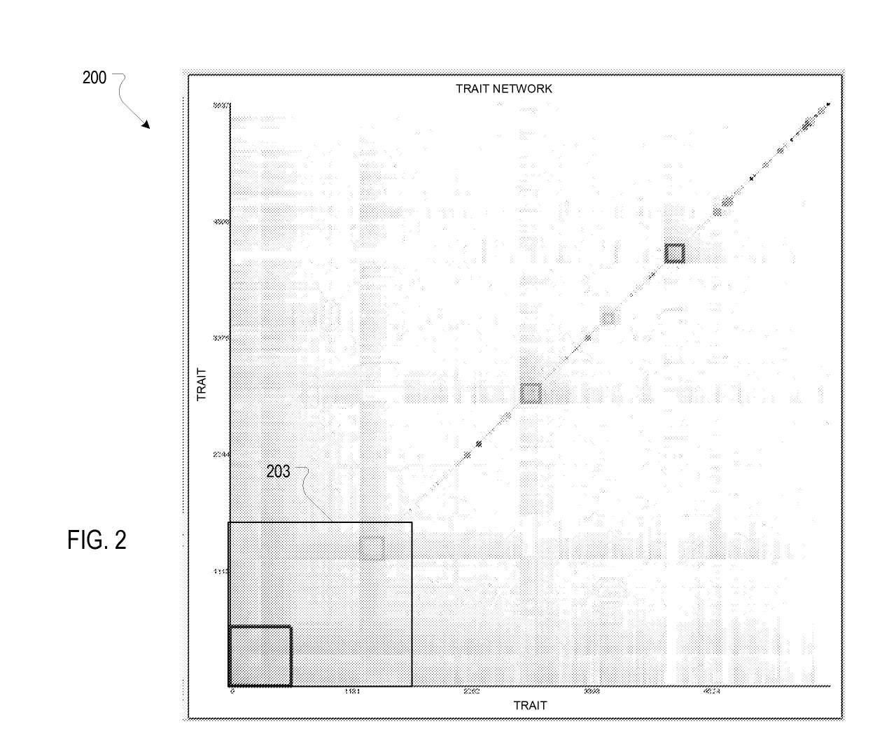

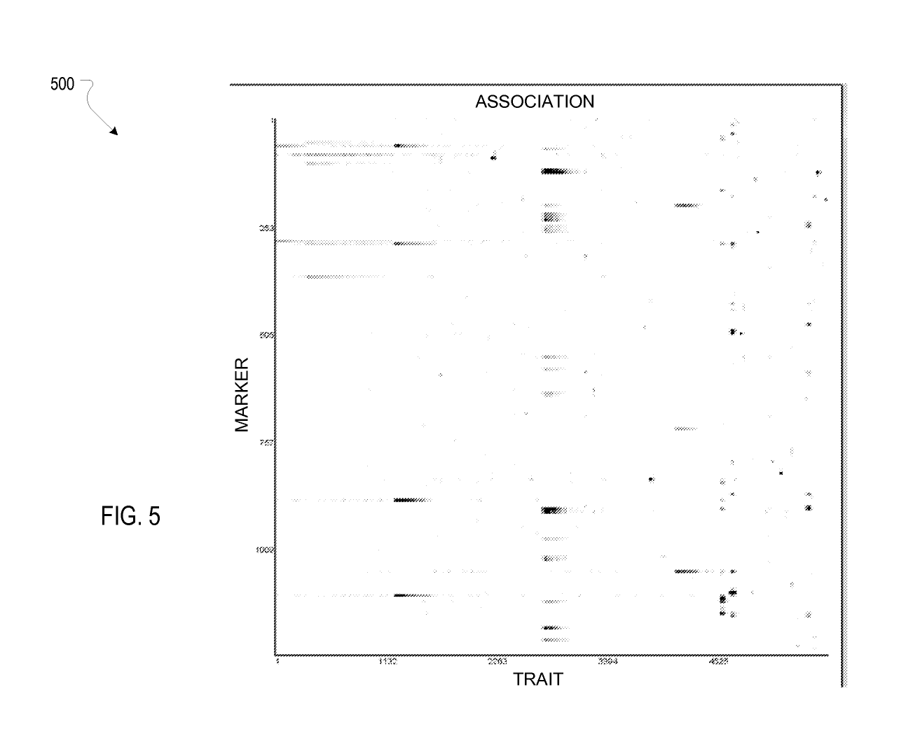

As described below, system 110 is configured to generate various visualizations (e.g., FIGS. 2-4) of the structure of trait data 106 and/or of genomic data 104, e.g., to promote selection of an appropriate one(s) of structured association algorithms 105. Following execution of the selected structured association algorithms 105, system 110 is configured to generate various visualization of structured association mapping 115 (e.g., FIGS. 5-8), e.g., to promote exploration of the various associations among genomic data 104 and trait data 106. As described herein, some of these associations may be identified by system 110 at least partly based on the structure of genomic data 104 and trait data 106.

### Network Representations

System 110 is configured to generate network representations of genomic data 104 and trait data 106. Generally, a network representation includes a visualization of a structure of genomic data 104 and/or trait data 106. For example, the structure of trait data 106 may be represented as a clustered network and/or as a gene network. Generally, a clustered network includes visual representations of items of data that have been grouped together based on similarities among the items of data. Through the network representation, a user of system 110 may determine one of structured association algorithms 105 that is appropriate to run on genomic data 104 and trait data 106.

In one example, genomic data 104 and trait data 106 includes a yeast eQTL dataset. This dataset is generated from a cross between the yeast BY4617 strain and the RM11-1a strain. The dataset has 5637 gene expression measurements and 1260 SNP markers from the two parent and 112 progeny strains. The yeast gene expression and SNP data are loaded into system 110, as trait data 106 and genomic data 104, respectively.

In this example, one of structured association algorithms 105 leverages gene structure to promote identification of associations among genomic data 104 and trait data 106. Referring to FIG. 2, system 110 generates visualization 200 of a gene network for the yeast data set. System 110, in one example, is used to explore this gene network to ensure that a structured approach (e.g., implementation of one of structured association algorithms 105) is appropriate for this data set. System 110 is configured to generate the gene network using well known techniques.

In this example, visualization 200 includes a network graph that is visualized in a hierarchically clustered matrix, showing a heat map of all edges between genes. Generally, a heat map includes a graphical representation of data where the individual values included in a matrix are represented as colors and/or in shades of gray. In visualization 200, gene modules are identified. In this example, for the yeast data, a 5637×5637 matrix is used. System 110 weighs the edges between traits, thus strong edges are shown as dark gray or black in the heat map, weak edges are shown as light gray, and no edge is represented as white. The hierarchical clustering ensures that strongly connected genes are shown next to each other in the heat map.

In one example, system 110 identifies gene modules in the network, in rectangular shapes in FIG. 2. Gene modules are regions of the network with many strongly-connected genes, e.g., relative to the connectedness of other genes in other regions of the network. The modules in the heat map are used to represent results from a gene-ontology (GO) enrichment test for the module. The GO enrichment test allows the user to identify the common function of the different gene modules. The gene modules are enriched for common GO categories in this case, and therefore the gene network is appropriate to use in a structured association analysis to find SNPs associated with functionally coherent groups of genes.

In one example, a gene cluster is expressed that is enriched for the GO category ribosome (p-value=2.6e-102). In an example, a user of system 110 can select portion 202 of visualization 200 to view additional details for selected portion 202. For example, selected portion 202 displays a portion of the gene cluster with a low p-value. In this example, selection of portion 202 causes system 110 generate a graphical user interface with a zoomed in representation of selected portion 202.

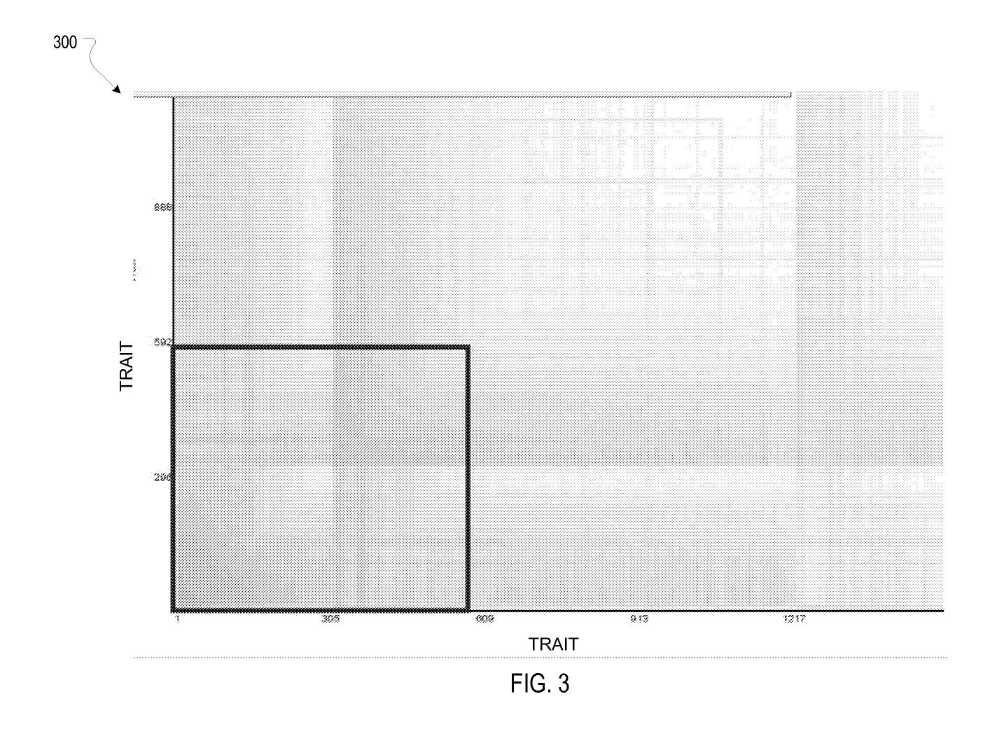

Referring to FIG. 3, visualization 300 provides a zoomed in representation of selected portion 202 of the network in the heat map. To explore the association between these genes, a GO analysis is performed in a node-edge representation of the first 150 genes in this region and finds that this specific set of genes are highly enriched for ribosome (p-value=8.5e-163).

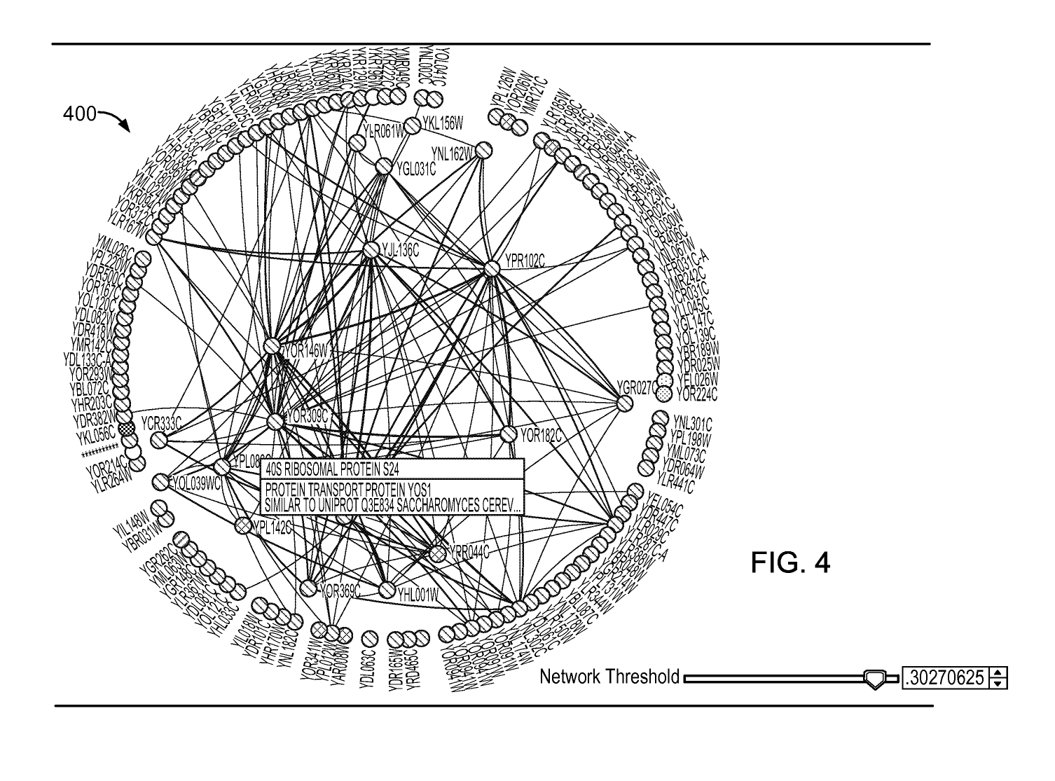

Referring to FIG. 4, in visualization 400, the genes are shaded by GO category, which reveals that every gene in the module is a ribosome gene. That is, visualization 400 include a node-edge representation of specific regions in the network shaded by GO category. In one example, because these genes are clustered together in the network, system 110 identifies that this module is made up of co-expressed ribosomal genes. In order to identify the key genes in the network, system 110 provides a user with controls to adjust the network threshold to add and remove edges. The genes with increased connectivity, e.g., relative to the connectivity of other genes, are moved to the center of the network shown in visualization 400.

### Network Association Representations

In one example, after using visualizations 200, 300, 400 to explore the structures of genomic data 104 and trait data 106, the system 110 selects one or more of structured association algorithms 105, e.g., based on attributes and/or qualities of the network. In this example, the selected ones of structured association algorithms 105 include a machine learning algorithm. Generally, a machine-learning algorithm includes a computer program that is configured to learn from experiences with respect to some class of tasks and performance measures, such that performance of the tasks improve with experience.

As previously described, the results of execution of the structured association algorithms 105 are included in structured association mapping 115. Referring to FIGS. 5-8, system 110 generates visualizations 500, 600, 700, 800, following completion of the structured association algorithms 105. In this example, visualizations 500, 600, 700, 800 include network association representations of structured association mapping 115 and/or of portions of structured association mapping 115. Generally, a network association representation includes a visualization of at least a portion of a structured association mapping. A user of system 110 may use visualizations 500, 600, 700, 800 to explore structured association mapping 115, e.g., by zooming into portions of visualizations 500, 600, 700, 800.

In an example, a network association representation includes a network representation integrated with a genome representation. Generally, a genome representation includes a visualization of a genome, including, e.g., the genome specified in genomic data 104. As with the network representation, in the network association representation, the overview of the data is explored. Additionally, the various representations of the data may be zoomed in and/or filtered. The network association representation incorporates tightly coupled coordinated representations, allowing a user of system 110 to interactively correlate between SNPs and the network. This representation is used to analyze a distribution of the data and associations among the data (e.g., genomic data 104 and trait data 106) and to find specific SNP-gene associations for further investigation.

Referring to FIG. 5, visualization 500 includes an overview of structured association mapping 115. In this example, visualization 500 includes a heat map. The heat map shows a matrix of the association values. Generally, an association value includes data indicative of a strength of an association between two items of data. In visualization 500, SNPs are shown along the y-axis, and the genes are shown along the x-axis; the traits have been clustered by hierarchical clustering. That is, visualization 500 includes an overview of structured association mapping 115 through a heat map representation, in which SNPs are plotted on the y axis and genes are plotted on the x axis. In this example, the yeast data associations are represented by a 1260×5637 matrix.

In the example of FIG. 5, portions of visualization 500 that are shaded black represent a strong association (e.g., relative to the strength of other associations) between items of genomic data 104 and items of trait data 106, and portions of visualization 500 that are white represent no association between items of genomic data 104 and items of trait data 106. In visualization 500, a user of system 110 can zoom in and out of the matrix through a series of resolutions. Each resolution is a 200 pixel by 200 pixel matrix. Structured association mapping 115 displayed in visualization 500 is at a resolution where each pixel represents, in one example, six SNPs and 30 genes. Because the data is inherently sparse, system 110 generates visualization 500 such that pixels are shaded by the maximum association value between all SNPs and traits represented, and the associations are preserved even at lower resolutions.

In one example, visualization 500 shows a series of long (and short) horizontal black lines in the matrix. These lines represent associations between a SNP and a cluster of genes. The presence of such patterns indicates to the user that gene clusters in the yeast network are associated with a common SNP. The overlap in lines indicates that some gene clusters are associated with multiple SNPs, representing a case where multiple mutations affect the same set of genes.

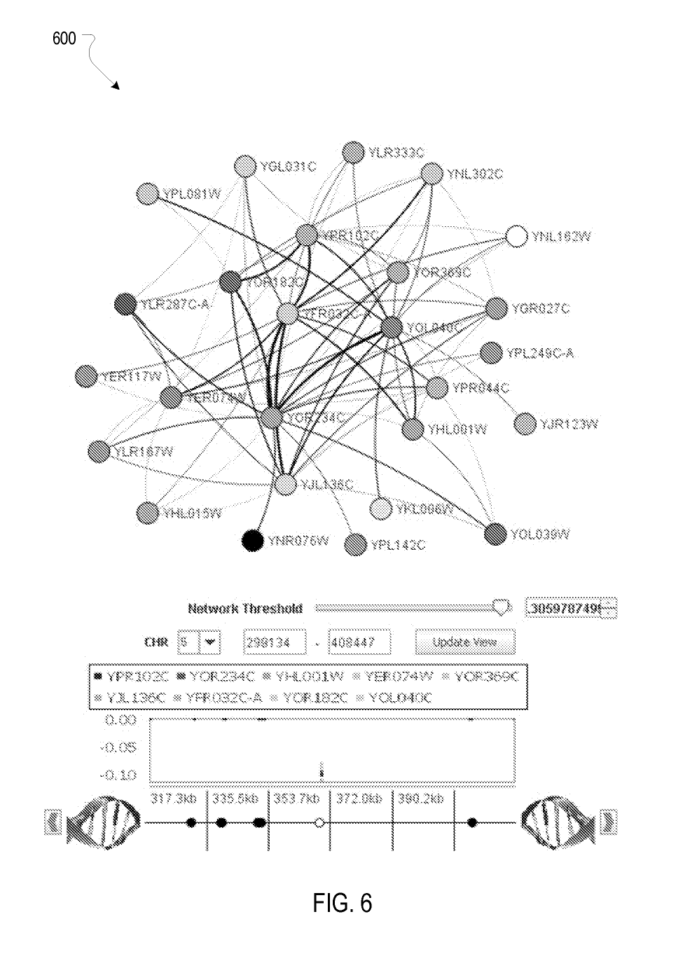

In one example, visualization 500 (e.g., a heat map representation) makes it clear which of the gene clusters are associated with multiple genetic locations and approximately where in the genome these association lie. The gene network data from the network representation is used to zoom into clusters of traits that are associated with different SNPs. Because the one-hundred-fifty ribosome genes were previously identified, the user is able to zoom to a part of the heat map associated with these genes and switch to the node-edge representation of the associations, as shown in visualization 600 in FIG. 6.

Referring to FIG. 6, visualization 600 displays interaction between genes, integrated with the association strengths of the genes to SNPs in the genome. In this example of FIG. 6, visualization 600 includes a node-edge representation of the network of genomic data 104 and trait data 106, e.g., for exploring the structure of the network while identifying associations. A node-edge representation includes a graph, in which one or more items of data are represented as nodes and edges represent associations among the nodes.

In this example, items of genomic data 104 are represented as nodes and the edges are indicative of traits that are related to the items of genomic data 104. In particular, visualization 600 is integrated with a simple genome browser where nodes represent SNPs. This genome browser is used to switch between chromosomes and zoom into certain chromosomal regions. Visualization 600 may include a genome representation.

For a particular analysis, the nodes in the genome representation are shaded in association to the genes in the network. This allows for the white colored SNP on chromosome five to be identified, ignoring the rest of the SNPs in the genome that are not associated with these genes. The network threshold on the network is adjusted to find the highest connected genes. After adjusting the threshold and removing unconnected genes, the twenty-five highly connected genes are located, as shown in visualization 600. These genes are shaded based on associations to the SNP located on chromosome five. In one example, a Manhattan plot is used of these genes. Generally, a Manhattan plan includes a logarithmically scaled scatter plot designed to highlight small variations from a normal range. In visualization 600, all of the genes are found to have some association to this SNP (because the nodes are not colored black), although the signal is much stronger for many of the genes as some are white or light gray and some are colored darker, representing weaker associations.

In one example, a system external to environment 100 (FIG. 1), including, e.g., the Universal Protein Resource, is used to query for data about these genes, and a particular gene (e.g., YER074W) gene is found to be located near this SNP in the genome. Through this analysis, system 110 identifies information related to this SNP and genes associated with this SNP.

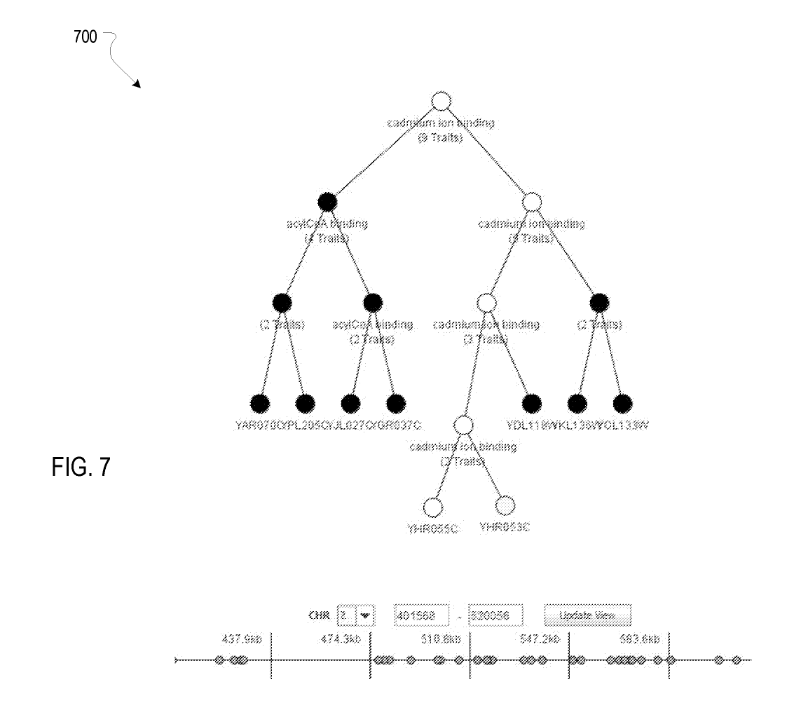

Referring to FIG. 7, visualization 700 includes an association tree representation of structured association mapping 115. Generally, an association tree representation includes a graph representing associations of a particular SNP or SNP region. Using the association tree representation, a user may determine if the genes associated with a SNP are located in a particular gene cluster. Using the association tree representation, the user may also identify associations (and strengths of the associations) from a SNP to genes. That is, in the association tree representation, the user explores genes structured as a tree, in order to identify functionally relevant branches of the tree that are associated with a genomic region.

In the association tree representation, the leaves of the tree represent genes, and other nodes represent the aggregation of genes descending from the genes. Each non-leaf node is labeled by the number of aggregated genes below the node and by a GO enrichment annotation (if the genes have a significant functional enrichment). The nodes are shaded based on this GO annotation. The association tree representation only shows three to eight levels of the tree at a time and allows the user to browse through the tree. In the association tree representation, the tree representation is integrated with the genome representation.

In one example, a genomic region on a particular chromosome (e.g., chromosome 2, base-pair 560000) is analyzed in structured association mapping 115. From the association tree representation, several SNPs are selected from the genomic location, and the tree is shaded by association to these SNPs. Each node in the tree is then shaded by strength of association to these SNPs. In this example, white represents a strong association to the genome location and black represents no association. As seen in visualization 700, a non-leaf node is shaded by the strength of the strongest association of all the traits it represents.

In one example, in order to find the strongest associations to these SNPs, starting at the root of the tree, the white nodes are followed, e.g., by system 110, to browse down the tree until a gene is found, e.g., as represented by the nodes in visualization 700. These genes are analyzed by system 110. In this example, visualization 700 includes links (not shown) to an external system that provides data about these genes. That is, through the selection of the links, a user may ascertain the types of genes and why the genes might be affected by mutations in this genomic location. Visualization 700 may also provide another link (not shown) to a reference about a particular SNP. In this example, the reference is included in another database, e.g., the Saccharomyces Genome Database (SGD). Further exploration in the tree allows for associations to be found between the genes and SNPs, identification of other related genes in the tree that are also associated, and an ability to discover the common GO enrichment of associated branches in the tree.

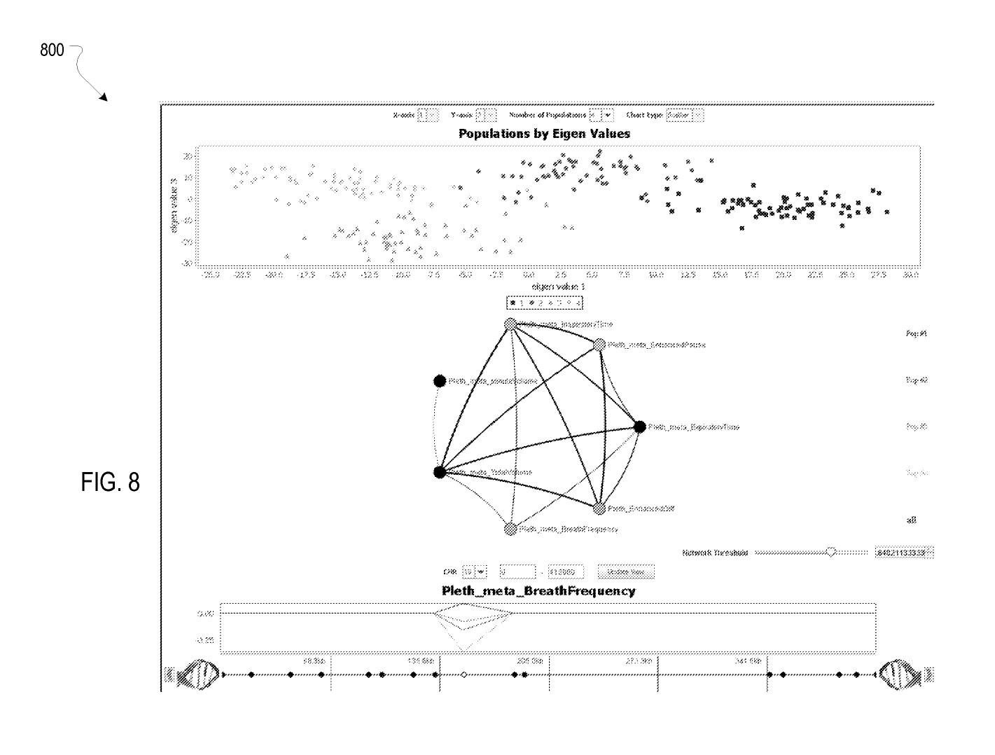

Referring FIG. 8, system 110 also generates visualization 800 of a population structure of structured association mapping 115. That is, visualization 800 provides a population association representation, including, e.g., an integrated representation enabling the exploration of association strengths across different populations. In a population structure, individuals are plotted according to their eigenvalues, and shaded according to population assignment. In this example, system 110 executes machine learning algorithms to generate the eigenvalues. Generally, the eigenvectors of a square matrix are the non-zero vectors that, after being multiplied by the matrix, remain parallel to the original vector. For each eigenvector, the corresponding eigenvalue is the factor by which the eigenvector is scaled when multiplied by the matrix.

Visualization 800 is shaded according to different numbers of populations. The number of individuals assigned to each population can be seen using a pie chart. In visualization 800, the individuals are split up into four distinct subpopulations across the first five eigenvalues.

In this example, visualization 800 integrates the population structure representation, the network representation, and the genome representation to help the user explore associations among genomic data 104 and trait data 106. The overall network is explored and various traits (e.g., traits related to a particular disease) are identified for further exploration.

In an example, system 110 is configured to explore the SNPs associated with these traits. The genome is shaded by association to these traits, and a SNP on a particular chromosome (e.g., chromosome 19) is identified that is strongly associated to at least one trait. This SNP is selected, which allows for the rest of the genome to be ignored, and the traits in the network are shaded that are associated to this SNP.

Each trait can be shaded by the color of the population with the largest beta value (e.g., association), e.g., relative to the beta value for other populations. In the example of FIG. 8, four asthma traits are found to be associated with this SNP, with the strongest association in each case being the association to the fourth population. The association is further investigated for each of these traits one-by-one by adding, in one example, the Manhattan plot to the genome representation.

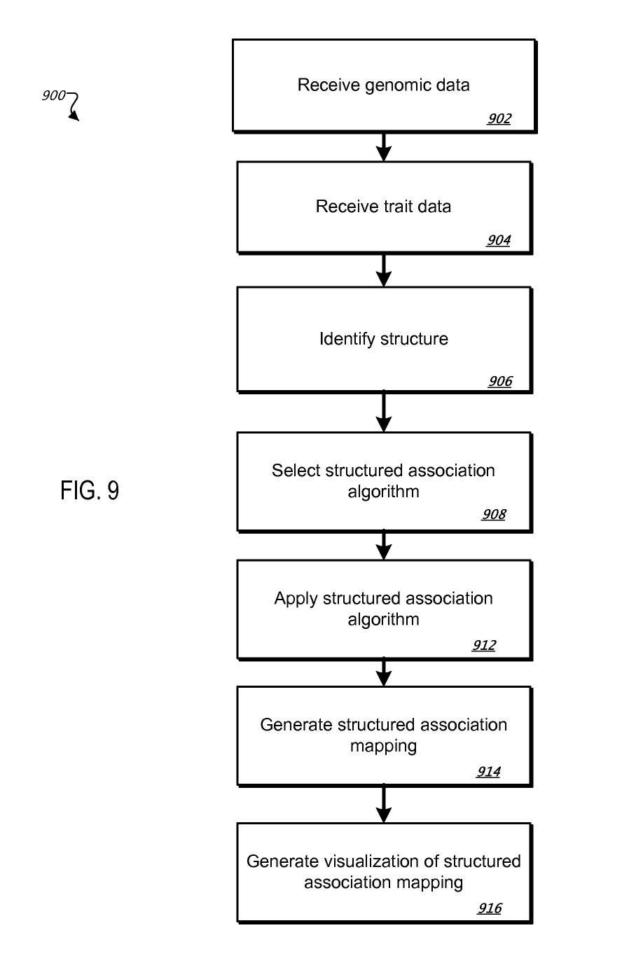

FIG. 9 is a flowchart of process 900 for generating a visualization of a structured association mapping. In operation, system 110 receives (902) genomic data 104. System 110 also receives (904) trait data 106. In response, system 110 identifies (906) a structure of genomic data 104 and trait data 106. Based on the identified structure, system 110 may generate visualizations (e.g., visualizations 200, 300, 400) of the structure. For example referring back to FIGS. 2, 3, 4, system 110 generates visualizations 200, 300, 400 to assist a user in selecting an appropriate one of structured association algorithms 105.

In the example of FIG. 9, system 110 selects (908) one or more of structured association algorithms 105. In response, system 110 applies (912) the selected structured association algorithm 105 to genomic data 104 and trait data 106. Based on application of the selected structured association algorithm 105, system 110 generates (914) structured association mapping 115. System 110 also generates (916) a visualization (e.g., visualizations 500, 600, 700, 800) of structured association mapping 115. For example, referring back to FIGS. 5-8, system 110 generally generates visualizations 500, 600, 700, 800 to promote exploration of the associations in genomic data 104 and in trait data 106, for example, by a user of system 110.

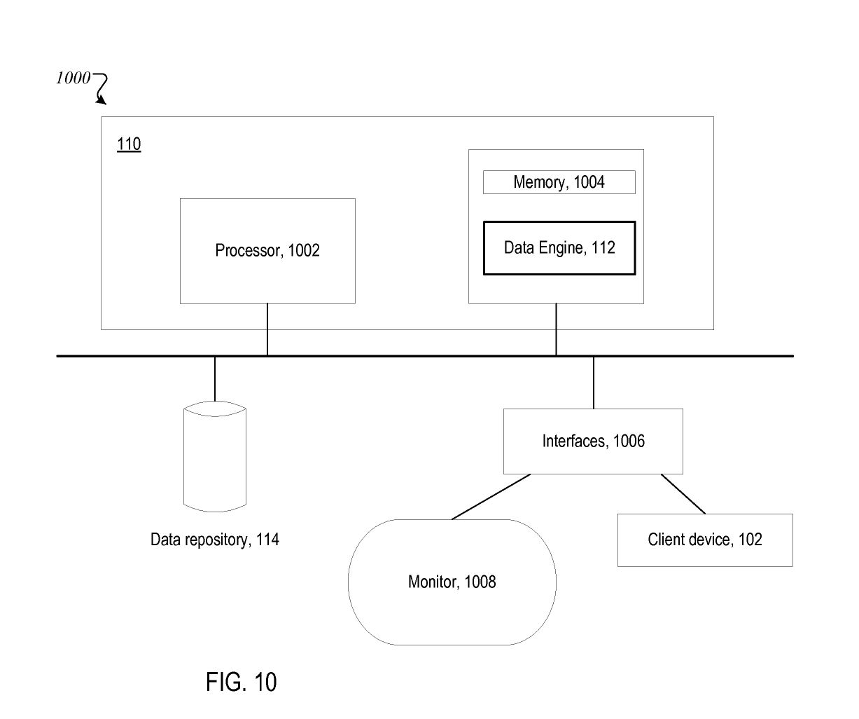

Referring to FIG. 10, components 1000 of an environment (e.g., environment 100) for generating visualizations of a structured association mapping. Client device 102 can be any sort of computing device capable of taking input from a user and communicating over a network (not shown) with server 110 and/or with other client devices. For example, client device 102 can be a mobile device, a desktop computer, a laptop, a cell phone, a personal digital assistant (“PDA”), a server, an embedded computing system, a mobile device and so forth. Client device 102 can include monitor 1108, which renders visual representations of interface 1106.

Server 110 can be any of a variety of computing devices capable of receiving data, such as a server, a distributed computing system, a desktop computer, a laptop, a cell phone, a rack-mounted server, and so forth. Server 110 may be a single server or a group of servers that are at a same location or at different locations.

Server 110 can receive data from client device 102 via interfaces 1106, including, e.g., graphical user interfaces. Interfaces 1106 can be any type of interface capable of receiving data over a network, such as an Ethernet interface, a wireless networking interface, a fiber-optic networking interface, a modem, and so forth. Server 110 also includes a processor 1002 and memory 1004. A bus system (not shown), including, for example, a data bus and a motherboard, can be used to establish and to control data communication between the components of server 110. In the example of FIG. 10, memory 1004 includes data engine 112.

Processor 1002 may include one or more microprocessors. Generally, processor 1002 may include any appropriate processor and/or logic that is capable of receiving and storing data, and of communicating over a network (not shown). Memory 2244 can include a hard drive and a random access memory storage device, such as a dynamic random access memory, machine-readable media, or other types of non-transitory machine-readable storage devices. Components 1000 also include data repository 114, which is configured to store data collected through server 110 and generated by server 110.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output.

The techniques described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Computer readable storage media are storage devices suitable for tangibly embodying computer program instructions and data include all forms of volatile memory such as RAM and non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Other embodiments are within the scope and spirit of the description claims. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method performed by one or more processors, comprising:
receiving genomic data and trait data representative of a plurality of traits of one or more individuals;
determining a structure of one or more of the genomic data and the trait data;
selecting, in response to the determined structure, a structured association algorithm for execution with the genomic data and the trait data;
generating, based on execution of the selected, structured association algorithm against the genomic data and the trait data, structured association data indicative of associations among the genomic data and the trait data, wherein the associations are at least partly identified based on the structure; and
generating data for a graphical user interface, that when rendered on a display device, comprises:
a visual representation of at least a portion of the structured association data.

2. The method of claim 1, wherein determining the structure comprises:
determining the structure based on one or more of (i) dependencies among items of the genomic data, and (ii) dependencies among items of the trait data.

3. The method of claim 1, wherein the genomic data is representative of a plurality of single nucleotide polymorphisms (SNPs).

4. The method of claim 1, wherein the visual representation comprises one or more of a gene network representation, a node-edge representation, a heat map representation, an association tree representation, and a population association representation.

5. The method of claim 1, further comprising:
filtering the structured association data.

6. The method of claim 5, further comprising:
generating data to update the graphical user interface with a visual representation of the filtered structured association data.

7. The method of claim 1, further comprising:
receiving a selection of a portion of the visual representation; and
causing the graphical user interface to be updated with data pertaining to structured association data displayed in the selected portion.

8. The method of claim 1, wherein the graphical user interface comprises a first graphical user interface, and wherein the method further comprises:
generating data for a second graphical user interface, that when rendered on the display device, comprises:
a visual representation of the structure.

9. One or more machine-readable media configured to store instructions that are executable by one or more processors to perform operations comprising:
receiving genomic data and trait data representative of a plurality of traits of one or more individuals;
determining a structure of one or more of the genomic data and the trait data;
selecting, in response to the determined structure, a structured association algorithm for execution with the genomic data and the trait data;
generating, based on execution of the selected, structured association algorithm against the genomic data and the trait data, structured association data indicative of associations among the genomic data and the trait data, wherein the associations are at least partly identified based on the structure; and
generating data for a graphical user interface, that when rendered on a display device, comprises:
a visual representation of at least a portion of the structured association data.

10. The one or more machine-readable media of claim 9, wherein determining the structure comprises:
determining the structure based on one or more of (i) dependencies among items of the genomic data, and (ii) dependencies among items of the trait data.

11. The one or more machine-readable media of claim 9, wherein the genomic data is representative of a plurality of single nucleotide polymorphisms (SNPs).

12. The one or more machine-readable media of claim 9, wherein the visual representation comprises one or more of a gene network representation, a node-edge representation, a heat map representation, an association tree representation, and a population association representation.

13. The one or more machine-readable media of claim 9, wherein the operations further comprise:
filtering the structured association data.

14. The one or more machine-readable media of claim 13, wherein the operations further comprise:
generating data to update the graphical user interface with a visual representation of the filtered structured association data.

15. The one or more machine-readable media of claim 9, wherein the operations further comprise:
receiving a selection of a portion of the visual representation; and
causing the graphical user interface to be updated with data pertaining to structured association data displayed in the selected portion.

16. The one or more machine-readable media of claim 9, wherein the graphical user interface comprises a first graphical user interface, and wherein the operations further comprise:
generating data for a second graphical user interface, that when rendered on the display device, comprises:
a visual representation of the structure.

17. An electronic system comprising:
one or more processors; and
one or more machine-readable media configured to store instructions that are executable by the one or more processors to perform operations comprising:
receiving genomic data and trait data representative of a plurality of traits of one or more individuals;
determining a structure of one or more of the genomic data and the trait data;
selecting, in response to the determined structure, a structured association algorithm for execution with the genomic data and the trait data;
generating, based on execution of the selected, structured association algorithm against the genomic data and the trait data, structured association data indicative of associations among the genomic data and the trait data, wherein the associations are at least partly identified based on the structure; and
generating data for a graphical user interface, that when rendered on a display device, comprises:
a visual representation of at least a portion of the structured association data.

18. The electronic system of claim 17, wherein determining the structure comprises:
determining the structure based on one or more of (i) dependencies among items of the genomic data, and (ii) dependencies among items of the trait data.

19. The electronic system of claim 17, wherein the genomic data is representative of a plurality of single nucleotide polymorphisms (SNPs).

20. The electronic system of claim 17, wherein the visual representation comprises one or more of a gene network representation, a node-edge representation, a heat map representation, an association tree representation, and a population association representation.

21. The electronic system of claim 17, wherein the operations further comprise:
filtering the structured association data.

22. The electronic system of claim 21, wherein the operations further comprise:
generating data to update the graphical user interface with a visual representation of the filtered structured association data.

23. The electronic system of claim 21, wherein the operations further comprise:
receiving a selection of a portion of the visual representation; and
causing the graphical user interface to be updated with data pertaining to structured association data displayed in the selected portion.

24. The electronic system of claim 21, wherein the graphical user interface comprises a first graphical user interface, and wherein the operations further comprise:
generating data for a second graphical user interface, that when rendered on the display device, comprises:
a visual representation of the structure.
